(19) United States
(12) Patent Application Publication
(10) Pub. No.: US 2006/0048009 A1
(43) Pub. Date: Mar. 2, 2006

(54) Device switch error injection

(76) Inventors: Louis D. Huemiller JR., San Jose, CA (US); Alan S. Driscoll, Fremont, CA (US); Jacques E. Hebert, Santa Clara, CA (US); Balaji S. Rao, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/933,108

(22) Filed: Sep. 1, 2004

(51) Int. Cl. G06F 11/00

(52) U.S. Cl. 714/32

(57) ABSTRACT

In an embodiment of the invention, an apparatus for device switch error injection, includes: an operating system kernel including a device driver and a device switch error driver. The device switch error driver intercepts a system call to the device driver to simulate a system call error. In another embodiment of the invention, a method for device switch error injection includes: receiving a system call from an application; and intercepting, by a device switch error driver, the system call to simulate a system call error.

### TECHNICAL FIELD

Embodiments of the present invention relate generally to computer systems, and more particularly to device switch error injection methods.

### BACKGROUND

Exception conditions denote extraordinary paths that are not frequently tested or encountered during software execution. Exception conditions include error conditions, retry paths, and backout paths. There are many different types of exception conditions that may occur during the execution of software. Some software or operating system exception conditions may be explicitly tested for, prior to execution of the software.

Corner case exception conditions are certain specific exception conditions that are encountered by software during execution (e.g., out of memory exceptions). Often, these types of exceptions are properly dealt with or handled by the software during execution as a process. In other words, upon encountering an exception, the process either stops execution in an ordered fashion or handles the exception occurrence in another way (e.g., if the process is unable to obtain needed resources from the operating system, the process may wait for additional resources to free up or it may free up some of the resources that are used in the process itself).

In the testing of device drivers, there are some corner case conditions that cannot be reproduced without using specific hardware configurations. In other words, some error conditions may be theoretical in nature and rarely occur in practice, and it is currently difficult to simulate these errors.

One prior method for testing exception conditions relies on external boxes that produce real physical errors on the cable(s) to a device. Typically, this external box will either interrupt all power to the device or will electrically interrupt the cable(s). These two techniques have the following disadvantage. First, these injection techniques are asynchronous in the injection of faults and are, therefore, non-deterministic. Non-deterministic injection of faults means that there is no guarantee that the exception that is being searched for will ever occur during the testing. Second, these injection techniques require special hardware. In other words, the tests can be executed only on special machines. Third, these injection techniques are only able to perform test handling or errors that are produced by the current device driver implementation. These injection techniques are unable to test for future error conditions.

Another current technique in error injection techniques is to use a logic analyzer with a vector board (pattern generation card). The logic analyzer is placed between a controller card and the actual hardware device such as a disk drive. This current technique allows the synchronous injection of faults, but is far more complicated than necessary. Furthermore, this technique had the disadvantages of requiring special hardware and is unable to simulate for future error conditions.

Another current technique involves adding kernel level test triggers into the higher level code, and the triggers are triggered on or off for purposes of code testing, as disclosed in commonly-assigned U.S. patent application Ser. No. 09/709,388, entitled “Software Trigger Facility For Code Testing and Use Thereof”, by Louis D. Huemiller Jr., et al., which is hereby fully incorporated herein by reference. The use of triggers is fully deterministic. The primary disadvantage with the use of triggers is that they require modification of the device driver. In contrast, no changes to a device driver are needed for a method of an embodiment of the invention. Instead, as discussed in detail below, a method of an embodiment of the invention will intercept requests to the driver and as needed, in order to simulate errors.

Therefore, the current technology is limited in its capabilities and suffers from at least the above constraints and deficiencies.

### SUMMARY OF EMBODIMENTS OF THE INVENTION

In an embodiment of the invention, an apparatus for device switch error injection, includes: an operating system kernel including a device driver and a device switch error driver. The device switch error driver intercepts a system call to the device driver to simulate a system call error.

In another embodiment of the invention, a method for device switch error injection includes: receiving a system call from an application; and intercepting, by a device switch error driver, the system call to simulate a system call error.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram of a computer system that can implement an embodiment of the invention.

FIG. 2 is a block diagram of system that includes a device switch error driver, in accordance with an embodiment of the invention.

FIG. 3 is a block diagram that illustrates an example operation of a device switch error driver, in accordance with an embodiment of the invention.

FIG. 4 is flowchart of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

Embodiments of the invention provide a software based ability to test the error handling capabilities of kernel software that is layered on top of device drivers (i.e., filesystems, volume managers, and/or the other software).

Embodiments of the invention provide the primary advantages of not requiring any special test hardware, by providing a software based solution, of permitting the deterministic injection of simulated errors, and by permitting errors simulation that the current device driver implementations do not produce. Additionally, embodiments of the invention may even simulate the setting of error codes that are not currently defined in error injection methods.

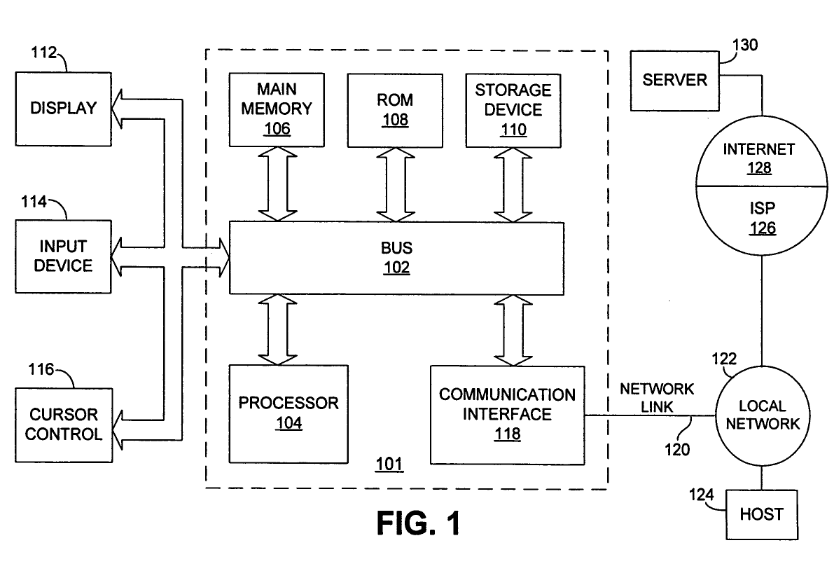

FIG. 1 is a block diagram illustrating an exemplary computer system 101 upon which an embodiment of the invention may be implemented. An embodiment of the invention is usable with currently available personal computers, mini-mainframes, enterprise servers, multi-processor computers, other computing devices, and the like.

Computer system 101 includes a bus 102 or other communication path for communicating information, and a processor 104 coupled with the bus 102, where the processor 104 can process information. Computer system 101 also includes a main memory 106, such as a random access memory (RAM) or other dynamic storage device, coupled to the bus 102, where the main memory 106 is configured for storing information and instructions to be executed by processor 104. Main memory 106 also may be used for storing temporary variables or other intermediate information during execution of instructions to be executed by processor 104. Computer system 101 further includes a read only memory (ROM) 108 or other static storage device coupled to the bus 102, where the ROM 108 is configured for storing static information and instructions for the processor 104. A storage device 110, such as a magnetic disk or optical disk, may be provided and coupled to the bus 102, where the storage device 110 is configured for storing information and instructions.

Computer system 101 may be coupled via the bus 102 to a display 112, such as a cathode ray tube (CRT) or a flat panel display, where the display 112 is configured for displaying information to a computer user. An input device 114, which may include alphanumeric and other keys, is coupled to the bus 102, where the input device 114 is configured for communicating information and command selections to the processor 104. Another type of user input device is cursor control 116, such as a mouse, a trackball, or cursor direction keys, where the cursor control 116 is configured for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

An embodiment of the invention is related to the use of a computer system 101, such as the illustrated system, to provide a mechanism for triggering and testing corner-case exception conditions in software and use thereof. According to one embodiment of the invention, a device switch error injection facility for testing software exception conditions is provided by computer system 101 in response to processor 104 executing sequences of instructions contained in main memory 106. Such instructions may be read into main memory 106 from another computer-readable medium, such as storage device 110.

However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other suitable memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement an embodiment of the invention. Thus, embodiments of the invention are not limited to any specific combination of hardware circuitry and software.

Computer system 101 also includes a communication interface 118 coupled to the bus 102. Communication interface 108 provides a two-way data communication as is known to those skilled in the art. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals which carry digital data streams representing various types of information. Of particular note, the communications through interface 118 may permit transmission or receipt of the operating software program scheduling information. For example, two or more computer systems 101 may be networked together in a conventional manner, with each computer system 101 using the communication interface 118.

Network link 120 typically provides data communication through one or more networks to other data devices. For example, network link 120 may provide a connection through local network 122 to a host computer 124 or to a data equipment operated by an Internet Service Provider (ISP) 126. ISP 126, in turn, provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 101, are exemplary forms of carrier waves transporting the information.

Computer system 101 can send messages and receive data, including program code, through the network(s), network link 120 and communication interface 118. In the Internet example, a server 130 might transmit a requested code for an application program through Internet 128, ISP 126, local network 122 and communication interface 118. In accordance with an embodiment of the invention, one such downloaded application provides for a method for testing exception conditions in software, as described herein.

The received code may be executed by processor 104 as it is received, and/or stored in storage device 110, or other non-volatile storage for later execution. In this manner, computer system 101 may obtain application code in the form of a carrier wave.

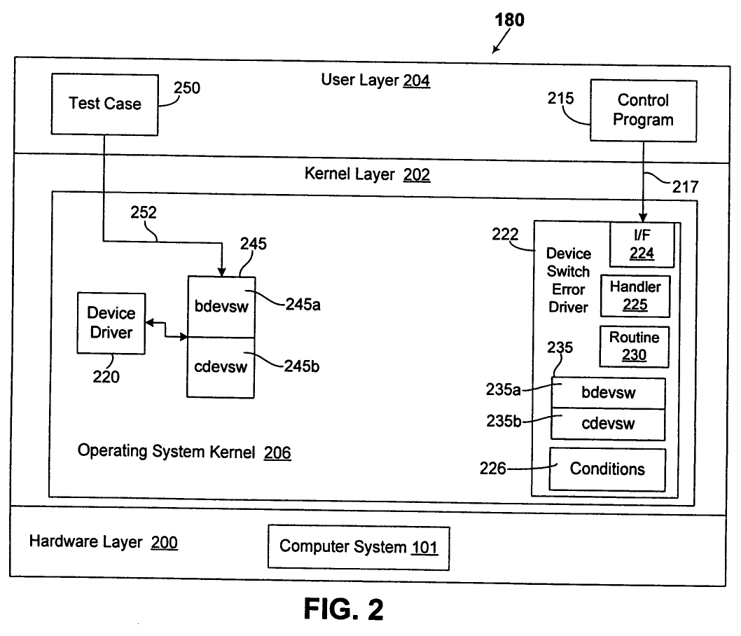

Reference is now made to FIG. 2, which illustrates a system 180, in accordance with an embodiment of the invention. The system 180 includes a hardware layer 200, a kernel layer 202, and a user layer 204. The hardware layer 200 includes the computer system 101 as previously shown in FIG. 1. The kernel layer 202 includes an operating system kernel 206. The operating system kernel 206 provides essential services such as, for example, memory management, process and task management, and disk management. The user layer 204 may include at least one application software that can operate in the computer system 180 and that communicates with the system kernel 206.

A device driver 220, in the kernel 206, may be a driver that is used by a device such as, for example, the storage device 110 (FIG. 1) or another device in the computer system 101. Multiple device drivers 220 may be in the kernel 206. As known to those skilled in the art, a device driver is a program that controls a particular type of device that is attached to a computer. A device driver essentially converts the more general input/output instructions of the operating system to messages that the particular device type can understand. The device driver is responsible for accessing the hardware registers of the particular device type and often includes an interrupt handler to service interrupts generated by the device type.

As known to those skilled in the art, every device driver in the UNIX environment will have entry points that are accessed by other applications (e.g., such as applications in the user layer 204 and by particular applications in the kernel layer 202). An application will access an entry point in the device driver by use of system calls. Typical entry points for a device driver include open( ), close( ), read( ), write( ), and ioctl( ), although a device driver could have additional types of entry points.

The open( ) entry point is accessed by an input/output (I/O) system call, so that the device associated with the device driver is opened and will be accessible to other software. When the device is opened, operation can be performed on the device such as, for example, read operations and/or write operations.

The close( ) entry point is accessed by an input/output (I/O) system call, so that the device associated with the device driver is closed. A device is typically closed after an operation on the device has been performed.

The read( ) entry point is accessed when a read operation is performed on the device.

The write( ) entry point is accessed when a write operation is performed on the device.

The ioctl( ) entry point is accessed if the characteristics of the device is to be changed, and is also used to query the state of the device. One example of an IOCTL call that would change the characteristics of a device is a command to a modem that tells the modem to hang-up. One example of an IOCTL call that performs a query is when an IOCTL call is used to determine the size of a disk. If the size of a device, such as a disk drive, is to be changed, then that characteristic change is performed by accessing the ioctl( ) entry point with input/output (I/O) system call.

The ioctl( ) entry point is also accessed in order to determine the device type associated with the device driver. The I/O call signal will be a call function that parses a file descriptor for the device, so that the characteristics of the device type is determined (e.g., if the device type is accessed with bit streams or by block data).

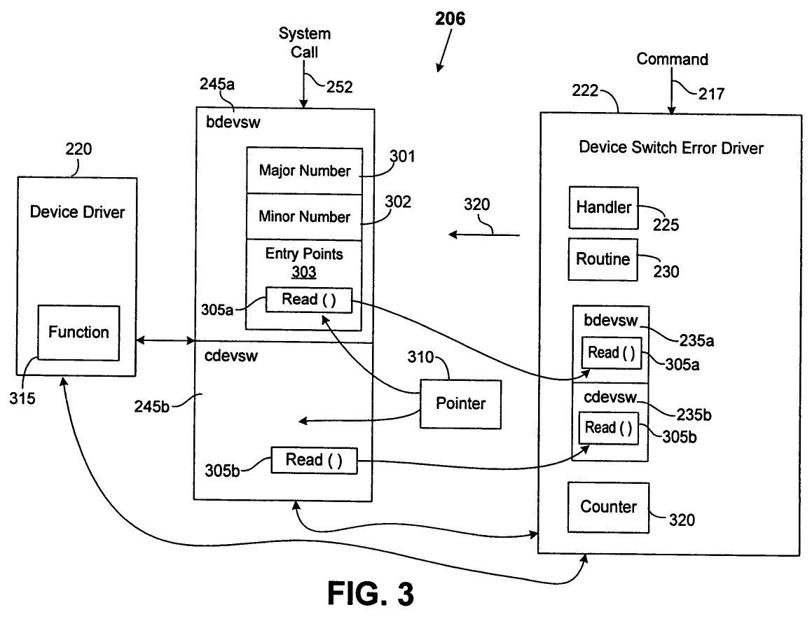

The entry points (e.g., open( ), close( ), read( ), write( ), and ioctl( )) of a particular device driver 220 are each registered by the device driver 220 in a global table 245 in the kernel 206. The details of the global table 245 are discussed below with reference to the example in FIG. 3. In order for software to access a driver entry point, an I/O system call (request) 252 from the software would access one of the global tables 245, and the appropriate entry in the global table 245 will determine the particular function within the kernel 206 for servicing the system call 252.

As shown in FIG. 3, the global table 245 includes a bdevsw global table 245a and cdevsw global table 245b. Normally, a device driver 220 only registers entries in one of the two tables 245a and 245b. For example, the device driver 220 will have registered entries in the table 245a or in the table 245b. An entry for a particular device driver 220 in the bdevsw global table 245a include a major number 301 which indicates the device type of the physical device associated with the particular device driver 220. For example, the major number 301 will indicate that the device type associated with device driver 220 is a SCSI driver.

The particular device driver 220 will also include a bdevsw global table 245a entry indicating a minor number 302 which contains the identity of the particular physical device associated with the device driver 220 and contains other specific information about the properties of the physical device.

The cdevsw global table 245b will also contain entries of major numbers and minor numbers of physical devices associated with device drivers in the kernel 206.

The cdevsw and bdevsw tables 245a and 245b do nothing with minor numbers. Instead, these tables 245a and 245b are accessed only by the major number of the device. The minor number is passed along to the device driver 220. The device driver 220 then uses the minor number to distinguish which one of the several devices (handled by the same device driver 220) is the target of the request 252.

The bdevsw global table 245a and cdevsw global table 245b contain entries 303 that indicate the registered the entry points (e.g., open( ), close( ), read( ), write( ), and ioctl( )) of a device driver 220. These entries 303 specify the particular device driver routines that are called by other applications. The I/O system calls from the user-layer applications are sent to the Virtual Filesystem (VFS) level of the kernel 206. The VFS subsystem (within the kernel 206) will use an entry 303 in the bdevsw global table 245a or cdevsw global table 245b in order to determine which particular function within the kernel 206 should receive the request in the I/O system call 252. Note that other kernel facilities (e.g., filesystems manager and volume manager), which are layered on top of device drivers 220, also use the entries in the bdevsw global table 245a or cdevsw global table 245b, so that the kernel facilities can communicate with the device drivers on which they are layered.

Devices support two modes of operations: block I/O mode and raw I/O mode. In the block I/O mode, the I/O call signals are formatted in a block size data (e.g., 1 kilobyte size data or other byte size data that depends on the operating system and the device type). The bdevsw global table 245a will contain entries for devices that support the block I/O mode. In the raw I/O mode (i.e., “character mode”), the I/O call signals are formatted as a byte-stream. The cdevsw global table 245b will contain entries for devices that support the raw I/O mode.

Referring again to FIG. 2, the device switch error driver 222 is now described in accordance with an embodiment of the invention. A control program 215 (typically, stored in the user layer 204) will invoke a device switch error driver 222 in accordance with an embodiment of the invention. The device switch error driver 222 is typically configured as part of the kernel layer 202. The control program 215 specifies the particular action(s) to be applied on a particular device driver 220 by sending a command(s) 217 that are received via an interface 224 of the device switch error driver 210. Therefore, the command 217 will specify to the device switch error driver 222 the particular actions to be applied to system calls 252, including simulating errors in response to system calls 252 or permitting the system calls 252 to invoke functions in the device driver 220.

Typically, the interface 224 is an I/O Control (IOCTL) based interface, and the control program 215 communicates with the device switch error driver 222 through the interface 224. For example, the control program 215 can send a command 217 that will permit the device switch error driver 210 to cause every fifth request (system call 252) to a particular device driver 220 to fail. Through the use of the device switch error driver 222, it is possible to simulate an I/O system call error, where the N^{th} I/O system call (request) 252 to a specific device will fail, where N can be any positive value. As another example, a command 217 can permit the device switch error driver 222 to cause every request to a particular device driver 220 to fail. As another example, the command 217 can specify that all requests to a particular device driver 220 should fail after a given number of requests (e.g., 10 requests) has been transmitted to the device driver 220. Other actions and error simulations can be invoked by use of the commands 217. Therefore, the control program 215 provides software to communicate with the device switch error driver 222.

A command 217 will permit the device switch error driver 222 to apply an action (i.e., simulate an I/O system call error) to be performed after the device switch error driver 222 detects the occurrence of a condition 226 (e.g., the device switch error driver 222 will monitor the requests to a particular device driver 220 and cause every fifth request to the particular device driver 220 to fail, if every fifth request is detected). The command 217 controls and sets the condition parameters 226 (typically stored in a table) that are to be monitored by the device switch error driver 222. When one of the conditions in the condition parameters 226 has occurred, then the device switch error driver 222 can perform the action as dictated in the command 217 so that an I/O system call error is simulated. The device switch error driver 222 will invoke a handler function 225 that accesses the global tables 245, in response to the command 217. The handler function 225 will replace entry points in the global tables 245 with function pointers to particular routines 230, based upon the actions to be applied by the device switch error driver 222 on the device driver 220. Therefore, the routines 230 will process the system call 252, after the system call 252 is pointed to the routine 230 by a function pointer. The operation of an example routine 230 is discussed below with reference to FIG. 3.

The handler function 225 also places the entry points (that have been replaced in the global tables 245) into the local tables 235. The local tables 235 are typically within the device switch error driver 222. Similar to the global tables 245, the local tables 235 includes a bdevsw local table 235a which will contain entries for devices that support the block I/O mode and a cdevsw local table 235b which will contain entries for devices that support the raw I/O mode. The device switch error driver 222 will typically inform the control program 215 that the action requested in the command 217 will be applied by the device switch error driver 222 to system calls 252.

Now assume that a test case program 250 performs an I/O system call 252 to the device driver 220. For example, the system call 252 may be a request by the test case program 250 to read from a disk drive associated with the device driver 220. The system call 252 will include a major number information that indicates the physical device to be addressed and other data indicating the type of requested action to be made to the physical device. The major number information and requested action type is compared with the entries in the global tables 245 to determine the proper device driver 220 to be addressed and the requested action type that is being sent in the system call 252. The kernel 206 matches the major number information and requested action type in the system call 252 with entries in the global tables 245. Assume that the requested action type in the system call 252 is a read request to a disk drive. The kernel 206 matches these information with the appropriate major number and the entry point, read( ), from the global table 245a or global table 245b, depending on whether block mode or raw I/O mode is used by the system call 252. Based on the actions that are indicated in the command 217, the handler 225 will replace particular entries in the global tables 245 with function pointers that points to the routines 230. If a particular system call 252 is permitted to succeed, then the routine 230 will call the original entry point, read( ), in the local tables 235 for the device, where this original entry point had been previously stored in the local tables 235. The original entry point, read( ), is accessed by the routine 230, and the routine 230 can call the appropriate function of the device driver 220 after accessing the entry point read( ).

On the other hand, if a particular system call 252 is to be subjected to failure, based on the action dictated by the command 216, then the routine 230 will not call the original entry point, read( ), in the local tables 235 for the device, where this original entry point had been previously stored in the local tables 235. Since the particular request(s) 252 is subjected to failure, the routine 230 will not access the relevant entry point in the appropriate local table 235. Since the routine 230 will not access the relevant entry point, the routine 230 will not call the appropriate function in the device driver 240. Instead, the routine 230 will return a message to the test case software 250, where the message indicates that the system call 252 has failed. Therefore, the device switch error driver 222 intercepts a system call 252 to the device driver 220 to simulate a system call error (failed system call).

Therefore, the device switch error driver 222 is able to hook the entries in the bdevsw table 245a and cdevsw table 245b. The device switch error driver 222 is able to perform the above operation by switching a current entry in the tables 245 with a function pointer that points to the functions in the routines 230 in the device switch error driver 222. By this method, any future I/O system call 252 directed to the device driver 220 will be intercepted and re-routed to the device switch error driver 222 instead, as described in the above example.

By intercepting the I/O system calls 252 to the device driver 220, the device switch error driver 222 can either pass on the system calls 252 to the device driver 220 so that the system calls 252 are handled under normal operations, or can prevent the system calls 252 from reaching the device driver 220 so that an I/O error condition is simulated. As described above, under normal operations (i.e., fault-free operations), the device switch error driver 222 passes the system calls 252 to the device driver 220 based on a lookup operation that is performed on the local tables 235 to determine the original entries in the tables 245. These original entries determine the particular device driver 220 function that needs to be called with a system call 252 is handled under normal operations. On the other hand, when an I/O error condition is simulated in response to a system call 252, the device switch error driver 222 will handle the system call 222 instead of passing on the system call 222 to the device driver 222. Under an I/O error condition, the device switch error driver 222 will handle the system call 222 by setting an error code and returning the system call 252 to the caller (software).

This deterministic nature in which the device switch error driver 222 can simulate I/O system call errors is one of the key benefits provided by embodiments of the invention. The device switch error driver 222 can cause a very specific I/O system call 252 to fail, cause all system calls 252 to fail, cause a randomly-selected system call 252 to fail, or cause other I/O error conditions as dictated by the command 217.

As another example, the device switch error driver 222 can simulate an I/O error either before or after the request 252 is passed on to the device driver 220 by the device switch error driver 222. This simulation is useful for simulating a write failure after the actual data to be written is modified. On an actual physical device, this I/O error situation occurs when some errors occur just before or during the return of the message that indicates that the write operation is completed. For example, this condition occurs if a cable fails or if there is a power failure when the physical device is returning an indication that the write operation has completed. In traditional methods, such error conditions are difficult to reproduce or simulate. This difficulty is mostly due to the time to send the completion message (indicating that the data has been written) is typically much shorter than the time to send the original request, which for a write operation, contains the data to be written. This leaves a very small window of time in which the device or cable to the device must fail. The device switch error driver 222 has the advantage in that it can reproduce such a condition in a deterministic manner.

In FIG. 2, the various software, firmware, or modules can be written in, for example, JAVA, C, C++, VISUAL BASIC, or other suitable programming languages, and can be programmed by use of standard code programming techniques such as, for example, object oriented programming.

Referring now to FIG. 3, an example operation is now described for the device switch error driver 222, in accordance with an embodiment of the invention. Assume in this example that the control program 215 specifies, via commands 217, that the device switch error driver 222 will cause every fifth read request 252 to a particular device driver 220 to fail. The device driver 220 may be associated with a specific example physical device such as, for example, a disk drive. The specific action of failing every fifth read request 252 to a disk driver is used in this example. However, the command 217 may also specify other type of actions to be applied to other types of commands such as, for example, write commands. Other types of actions to simulate I/O system call failure conditions have been described above.

In response to the command 217, the handler function 225 accesses the global tables 245, in response to the command 217. The handler function 225 will replace entry points in the global tables 245 with pointers to particular routines 230, based upon the actions to be applied on the device driver 220. In this example, since the command 217 will cause every fifth read request 252 to fail, the handler function 225 will replace the registered read entry points 305 (i.e., read( ) 305a in bdevsw global table 245a and read( ) 305b in cdevsw global table 245b) with function pointers 310 that will point any read request 252 to the routine 230. The handler function 225 will also place the read entry points 305a and 305b in the bdevsw local table 235a and cdevsw local table 235b, respectively.

The read request 252 is directed to the appropriate device driver based upon the major number 301 of the device driver in one of the global tables (bdevsw 245a or cdevsw 245b), depending on whether the block I/O mode or in the raw I/O mode is used for the read request 252.

In this example, the first four read requests 252 will be permitted to succeed, while every fifth read request 252 will be subject to failure. Assume that the block I/O mode is used for the read requests 252. Therefore, the kernel 206 will compare the contents of the read requests 252 with the entries in the bdevsw global table 245a. On the other hand, if the raw I/O mode is used for the read request 252, then the kernel 206 will compare the contents of the read requests 252 with the entries in the cdevsw global table 245b. For the first four read requests 252, the function pointer 310 will point the read requests 252 to an appropriate routine 230 which will then call the original entry point, read( ) 305a, that has been previously stored in the bdevsw local table 235a. Note that if the raw I/O mode is used for the read request 252, then the routine 230 will call the original entry point, read( ) 305b, that has been stored in the cdevsw local table 235b. The routine 230 can then call the appropriate function 315 of the device driver 220 in response to the read requests 252 and after accessing the entry point read( ) 305a in the bdevsw local table 235a.

The I/O system call failure condition is now described for this example. For the fifth read request 252 which will be subject to failure, the function pointer 310 will also point the fifth request 252 to the appropriate routine 230. The routine 230 will determine from a counter value 320 in the device switch error driver 222 that a fifth read requests 252 has been received by the routine 230. Since every fifth request 252 in this particular example is subjected to failure, the routine 230 will not call the access the entry point, read( ) 305a, in the bedevsw local table 235a. As a result, the routine 230 will not call the appropriate function 315 in the device driver 220 in response to every fifth read request 252. Instead, the routine 230 will return a message 320 that is sent to the test case software 250, where the message 320 indicates that the read request 252 has failed. Therefore, the device switch error driver 222 can simulate a failed system call 252 as shown by the above example. Errors can be simulated for write requests and other types of system calls 252 based on the method described in the above example.

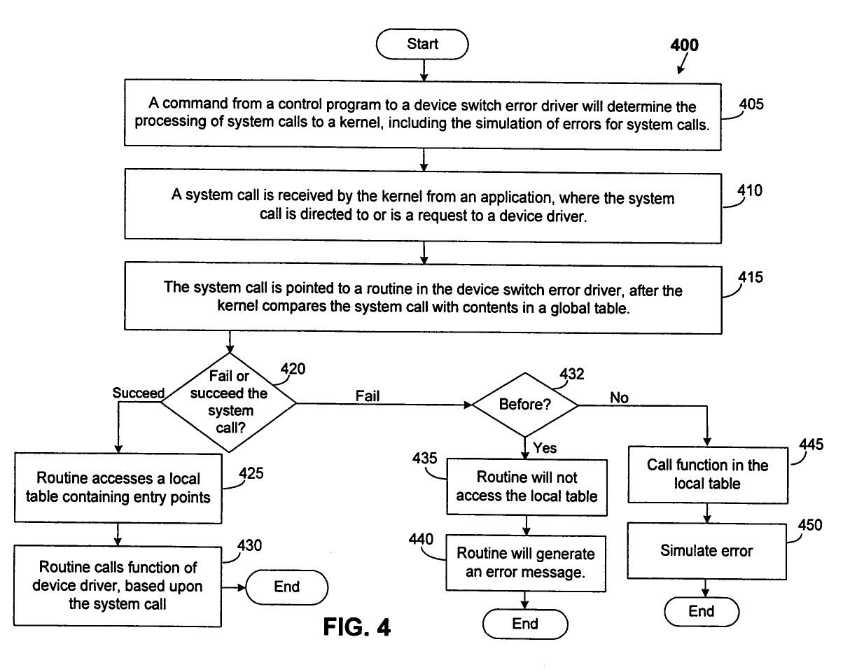

FIG. 4 is flowchart of a method 400 in accordance with an embodiment of the invention. In step (405), a command from a control program to a device switch error driver will determine the processing of system calls to a kernel, including the simulation of errors for system calls.

In step (410), a system call is received by the kernel from an application, where the system call is directed to or is a request to a device driver. In step (415) the system call is pointed to a routine in a device switch error driver, after the kernel compares the system call with contents in a global table. In step (420), the routine determines if the system call is permitted to succeed or to fail. As an example, the routine will read a counter value in order to determine if the system call will be permitted to succeed or be subjected to failure. If the system call is permitted to succeed, then the routine will access a local table containing entry points for the device driver, as shown in step (425). After the routine accesses an appropriate entry point in the local table, then the routine can call an appropriate function in the device driver, based upon the system call, as shown in step (430).

On the other hand, if the system call is permitted to fail, then in step (432), the routine determines if an I/O error is to be simulated before or after a request 252 is passed on to the device driver 220 by the device switch error driver 222.

If the error is to be simulated before the request is passed on to the device driver, then the routine will not access the local table, as shown in step (435). The routine will the generate an error message that is sent to the application, in order to indicate failure of the system call, as shown in step (440).

If, in step (432), the error is to be simulated after the request is passed on to the device driver, then the routine will call a function in the local table as shown in step (445). An error is then simulated as shown in step (450).

The various drivers, routines, functions, engines, tools, or modules discussed herein may be, for example, software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for device switch error injection, the apparatus comprising:
an operating system kernel including a device driver and a device switch error driver;
wherein the device switch error driver intercepts a system call to the device driver to simulate a system call error.

2. The apparatus of claim 1, wherein the device switch error driver is configured to receive a command that will specify an action to be performed by the device switch error driver in response to a system call.

3. The apparatus of claim 1, wherein the device switch error driver includes a handler function configured to replace entry points in a global table with a function pointer to a routine.

4. The apparatus of claim 3, wherein the handler function is configured to place an entry point in a local table.

5. The apparatus of claim 4, wherein the routine is configured to access the local table for the entry point, if the system call is not subject to error.

6. The apparatus of claim 5, wherein the entry point permits the routine to call an appropriate function of the device driver in response to the system call.

7. The apparatus of claim 4, wherein the routine is configured to not access the local table for the entry point, if the system call is subject to error.

8. The apparatus of claim 7, wherein the routine will not call an appropriate function of the device driver in response to the system call.

9. The apparatus of claim 7, wherein the routine is configured to return an error message in response to an error of the system call.

10. A method for device switch error injection, the method comprising:
receiving a system call from an application; and
intercepting, by a device switch error driver, the system call to simulate a system call error.

11. The method of claim 10, further comprising:
receiving a command that will specify an action to be performed by the device switch error driver in response to a system call.

12. The method of claim 10, further comprising:
replacing entry points in a global table with a function pointer to a routine.

13. The method of claim 12, further comprising:
placing an entry point in a local table.

14. The method of claim 12, further comprising:
accessing the local table for the entry point, if the system call is not subject to error.

15. The method of claim 14, further comprising:
calling an appropriate function of the device driver in response to the system call.

16. The method of claim 15, further comprising:
preventing access to the local table with the entry point, if the system call is subject to error.

17. The method of claim 16, further comprising:
preventing the calling of an appropriate function of the device driver in response to the system call.

18. The method of claim 17, further comprising:
returning an error message in response to an error of the system call.

19. An article of manufacture, comprising:
a machine-readable medium having stored thereon instructions to:
receive a system call from an application; and
intercept the system call to simulate a system call error.

20. An apparatus for device switch error injection, the apparatus comprising:
means for receiving a system call from an application; and
means for intercepting the system call to simulate a system call error.
